(19) United States
(12) Patent Application Publication
(10) Pub. No.: US 2011/0188343 A1
(43) Pub. Date: Aug. 4, 2011

(54) Random Transmitter Placement Method For Stationary Seismic Imaging

(76) Inventors: Jacques Y. Guigné, Paradise (CA); Nicholas G. Pace, Bath (GB); Gary J. Dinn, Paradise (CA)

(21) Appl. No.: 12/700,040

(22) Filed: Feb. 4, 2010

(51) Int. Cl. G01V 1/38

(52) U.S. Cl. 367/15

(57) ABSTRACT

A method for at least one of imparting seismic energy into formations below the bottom of a body of water and detecting seismic energy therefrom includes releasing a plurality of acoustic transducers into the water. The transducers move to the bottom by gravity. A geodetic position of each of the transducers on the water bottom is determined. At least one of the following is performed: actuating each of the transducers as a transmitter at least once, the actuating of each transducer occurring at a time selected to cause seismic energy to be imparted into the formations in a beam along a selected direction, the selected time related to relative positions of the transducers; and recording signals detected by each of the transducers, the recording including adding a selected time delay to cause response of the transducers to be amplified along a selected direction.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic imaging of rock formations below the Earth's surface. More particularly, the invention relates to deployment of steerable acoustic transmitter arrays that have practical application in subsea environments.

2. Background Art

U.S. Patent Application No. 2009/0122645 filed by Guigné et al, the underlying patent application for which is commonly owned with the present invention, describes a method for obtaining high resolution seismic images of subsurface formations by deploying a stationary array of seismic sensors in a selected pattern above a volume of the subsurface to be imaged. An acoustic transmitter is disposed proximate the sensor array. The transmitter is repeatedly actuated, and response of the seismic sensor array is beam steered to selected positions in the subsurface. The repeated actuation of the transmitter and the beam steering of the sensor array response enables much higher resolution seismic imaging than conventional seismic surveying techniques.

The foregoing publication also describes the use of an array of transmitters having steerable energy output for more detailed imaging. An example of such an array is shown in FIG. 1. The transmitter array 12 includes two concentric circles of transmitters 10, each containing 16 transmitters 10, and one transmitter at the center of the array 12. The radial spacing between the two circles is 8 meters (1 wavelength at 200 Hz transmitter frequency) with the first circle at 8 meters from the center of the array 12. At transmitter frequencies other than 200 Hz the spacing in wavelengths between the circles will change correspondingly. Such arrays may be referred to as regular geometric arrays, or substantially similar designation.

In marine seismic surveying, where the transmitters and sensors are deployed on the bottom of a body of water, typically from a vessel on the water surface, it can be impractical to deploy a regular geometric array such as the one shown in FIG. 1. What is needed is a more practical technique to deploy an array of acoustic transmitters for seismic imaging below the water bottom.

### SUMMARY OF THE INVENTION

A method for at least one of imparting seismic energy into formations below the bottom of a body of water and detecting seismic energy therefrom includes releasing a plurality of acoustic transducers into the water. The transducers move to the bottom by gravity. A geodetic position of each of the transducers on the water bottom is determined. At least one of the following is performed: actuating each of the transducers as a transmitter at least once, the actuating of each transducer occurring at a time selected to cause seismic energy to be imparted into the formations in a beam along a selected direction, the selected time related to relative positions of the transducers; and recording signals detected by each of the transducers, the recording including adding a selected time delay to cause response of the transducers to be amplified along a selected direction.

Other aspects and advantages of the invention will be apparent from the following description and the appended claims.

### BRIEF DESCRIPTION OF THE DRAWINGS

FIG. 1 shows a prior art acoustic transmitter array wherein the transmitters are arranged in a regular geometric pattern (circular).

FIG. 2 shows simulated transmitter locations for twenty different random position sets generated by a first random number technique.

FIG. 3 shows simulated beam steered output of the transmitters located at each of the corresponding location sets in FIG. 2. The beam steering angle is zero.

FIG. 4 shows simulated transmitter locations for twenty different random position sets generated by a second random number technique.

FIG. 5 shows simulated beam steered output of the transmitters located at each of the corresponding location sets in FIG. 4. The beam steering angle is zero.

FIG. 6 shows twenty sets of simulated transmitter locations again using the first technique.

FIG. 7 shows beam steered output for each of the sets of transmitters of FIG. 6. The beam steering angle is 45 degrees.

FIG. 8 shows twenty sets of simulated transmitter locations again using the second technique.

FIG. 9 shows beam steered output for each of the sets of transmitters of FIG. 8. The beam steering angle is 45 degrees.

FIG. 10 shows an example acoustic transmitter.

FIG. 10A shows a functional block diagram of circuits in the example transmitter of FIG. 10.

FIG. 11 shows deployment and retrieval of transmitters.

FIG. 11A is a plan view of the deployment shown in FIG. 11.

### DETAILED DESCRIPTION

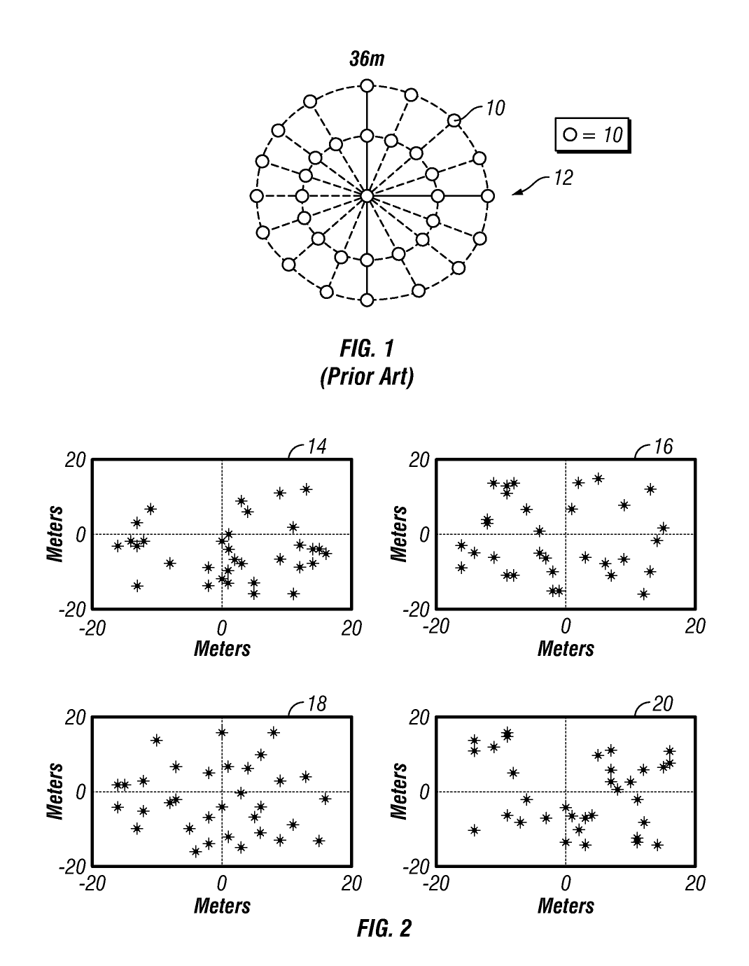

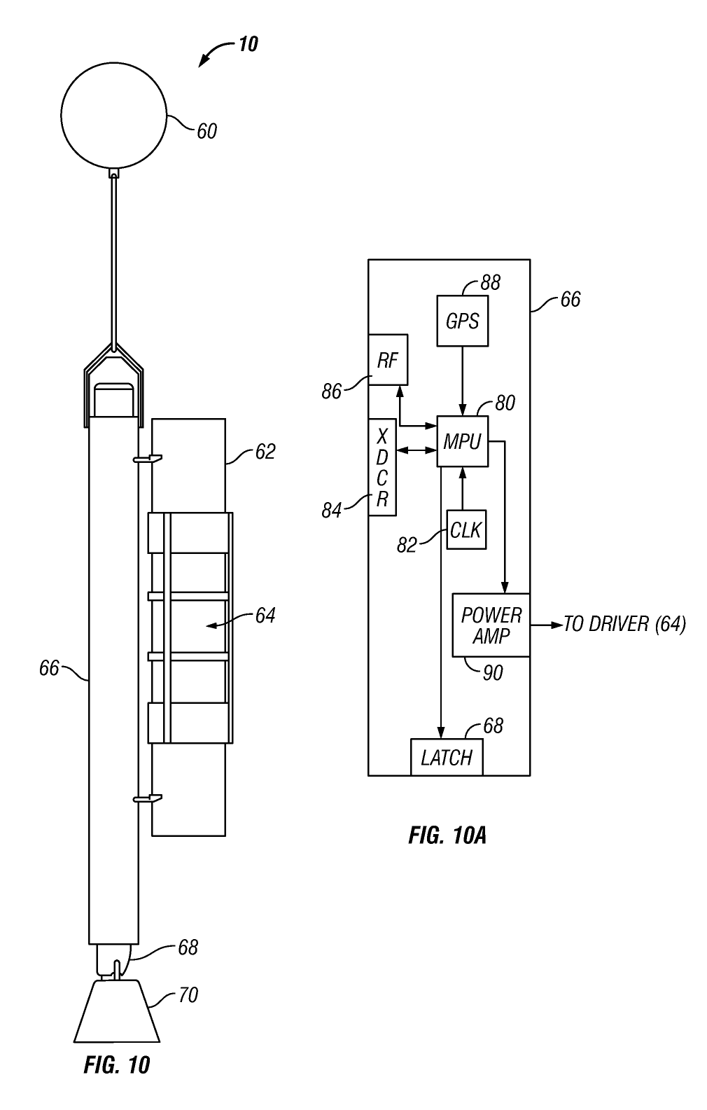

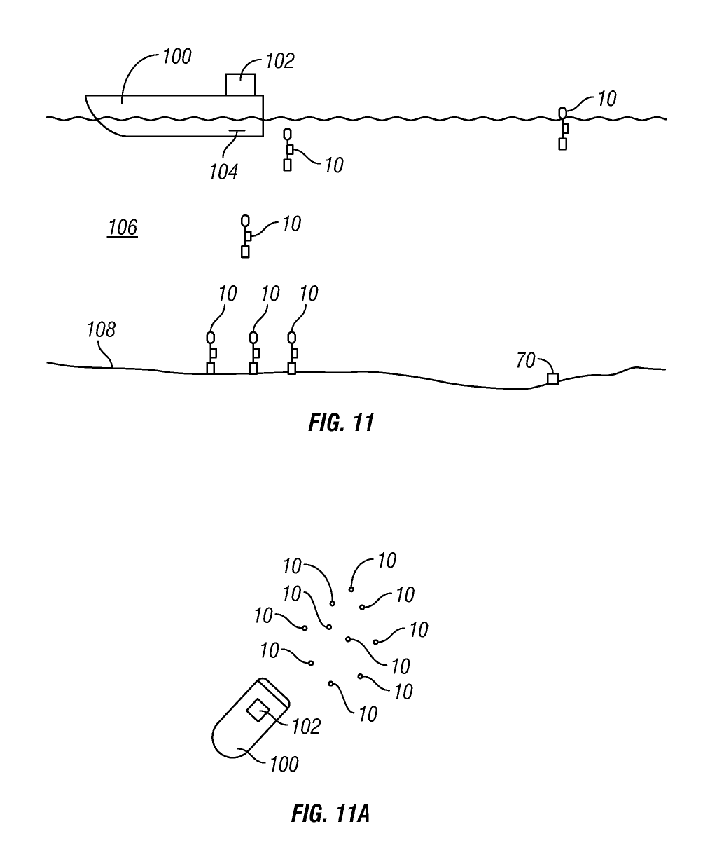

As explained in the Background section herein, deployment of a regular geometric array of devices onto the bottom of a body of water, such as the acoustic transmitter array shown in FIG. 1, can be difficult to perform. The present invention contemplates deployment of individual acoustic transmitters into a body of water from proximate the surface, such as from a ship or survey vessel, and allowing each transmitter to fall to the water bottom without controlling the exact geodetic position at which each of the transmitters reach the water bottom. Such deployment can reasonably be expected to result in the transmitters being located approximately randomly on the water bottom. An example transmitter and example method of deployment will be further explained below with reference to FIGS. 10, 10A, 11 and 11A.

In the present invention, it has been determined that transmitters positioned at randomly distributed locations can be operated as a steered beam array in a manner having beam steering response similar to that of regular geometric arrays. What follows is an explanation of simulation of response of randomly located transmitters, wherein the transmitters are actuated to form a beam steered array output.

Response of various random transmitter array geometries were simulated, along with simulation the response of a regular geometric array. The number of transmitters and the area over which the transmitters are distributed in the case of the randomly distributed transmitter array were kept the same as for the regular geometric array shown in FIG. 1. Thus, for the regular geometric array the area is π(2λ)² where λ represents the acoustic energy wavelength.

For the randomly distributed arrays, a square area having side length 4λ was used in the simulation. This was used to ensure the main beam is approximately the same width for the randomly distributed transmitters as for the regular geometric array.

In a first technique for determining position of each transmitter in a randomly distributed array, the Cartesian (x, y) coordinates (with 0, 0 being in the center of the area) of each of 33 transmitters were obtained from the function “randint”, using a computer program sold under the trademark MATLAB, which is a registered trademark of The MathWorks, Inc., Cochituate Place, 24 Prime Park Way, Natick, Mass. 01760. “L” in the expressions below represents wavelength of the acoustic energy, which for the present example is 8 meters.

x=(randint(1.33,[−2.*L,2.*L]))

y=(randint(1.33,[−2.*L,2.*L]))

The foregoing expressions produce 33 uniformly distributed, randomly selected integers in the range −2λ to 2λ. The foregoing expressions may be referred to for convenience as the first transmitter position determining method.

Another way in which the random distribution of transmitter positions was produced for response simulation was to use the transmitter positions of the regular array shown in FIG. 1, and move the transmitter positions by increasingly larger standard deviations. The following expressions are used where (xz, yz) are the original coordinates of the transmitters in the concentric circular array shown in FIG. 1, a standard deviation index, i, increases from 0 to 19 and the function “randn” from the MATLAB program produces 33 normally distributed random numbers.

xzr=xz+randn(1.33)*0.2*i

yzr=yz+randn(1.33)*0.2*i

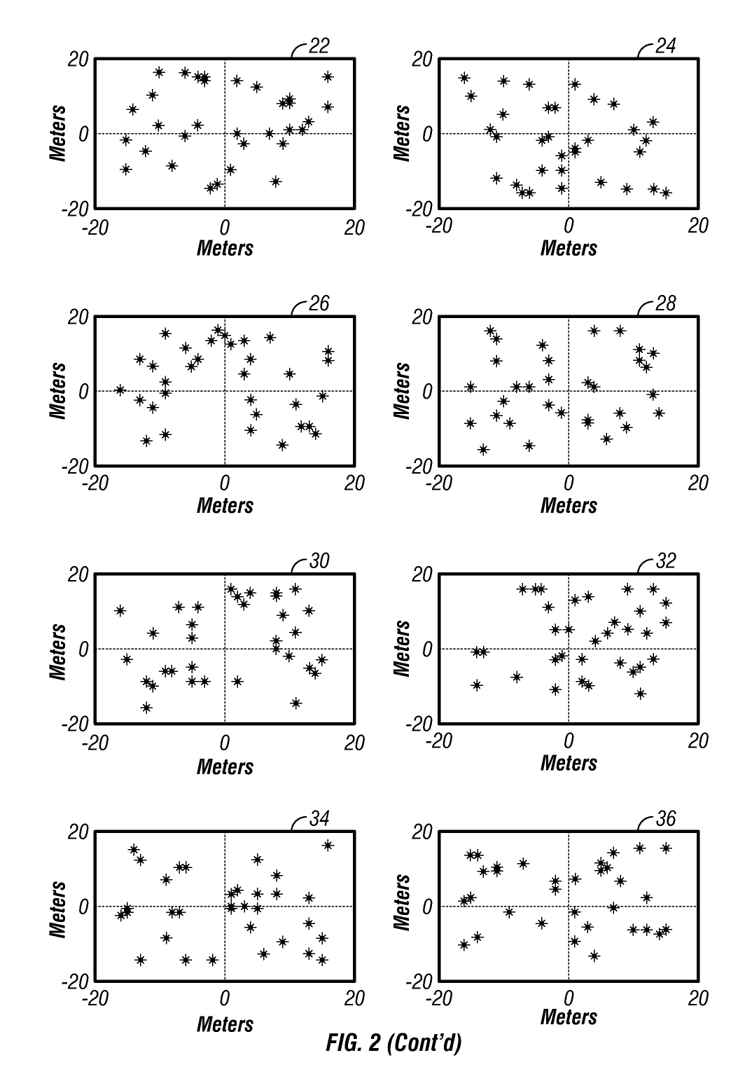

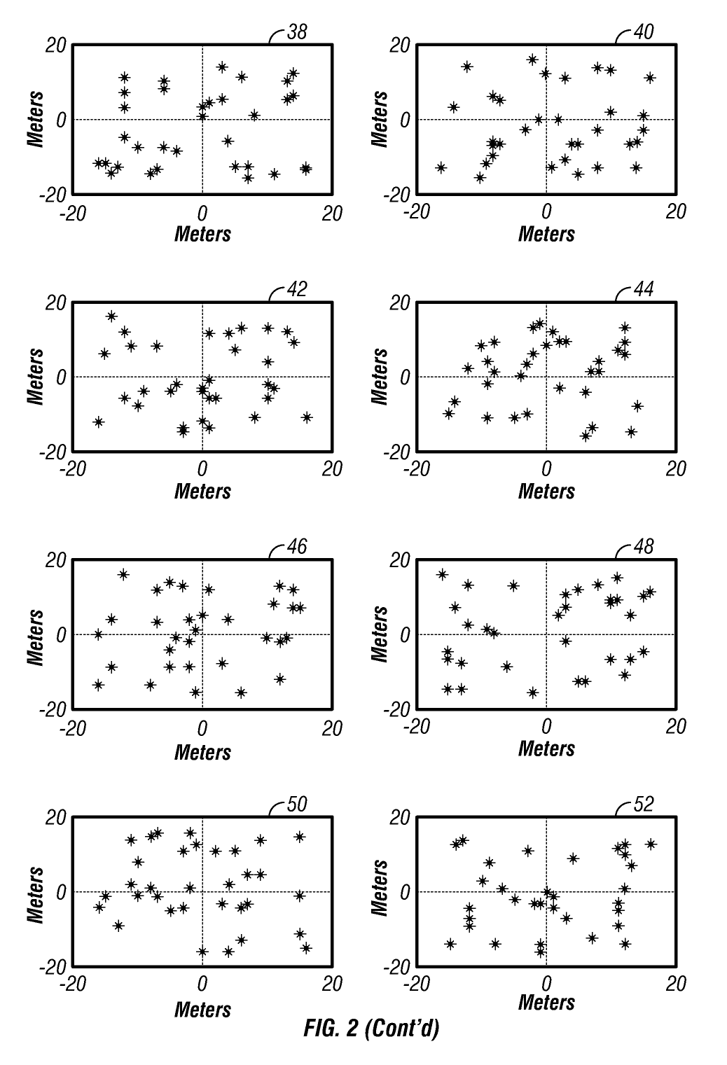

The foregoing expressions may be referred to as the second transmitter position determining method. Results of the simulations using each of the above two position determination techniques are shown in FIGS. 2 through 9. In FIG. 2, the positions of the transmitters in each of the graphs in FIG. 2 are shown by the + symbol as calculated using the first position determination method explained above. The first method was performed twenty separate times, with the results being shown in the respective graphs 14 through 52. There are 33 simulated transmitter positions in each graph 14 through 52, just as in the regular geometric array shown in FIG. 1. Coordinate axes in graphs 14 through 52 are scaled in meters, where the energy wavelength is 8 meters.

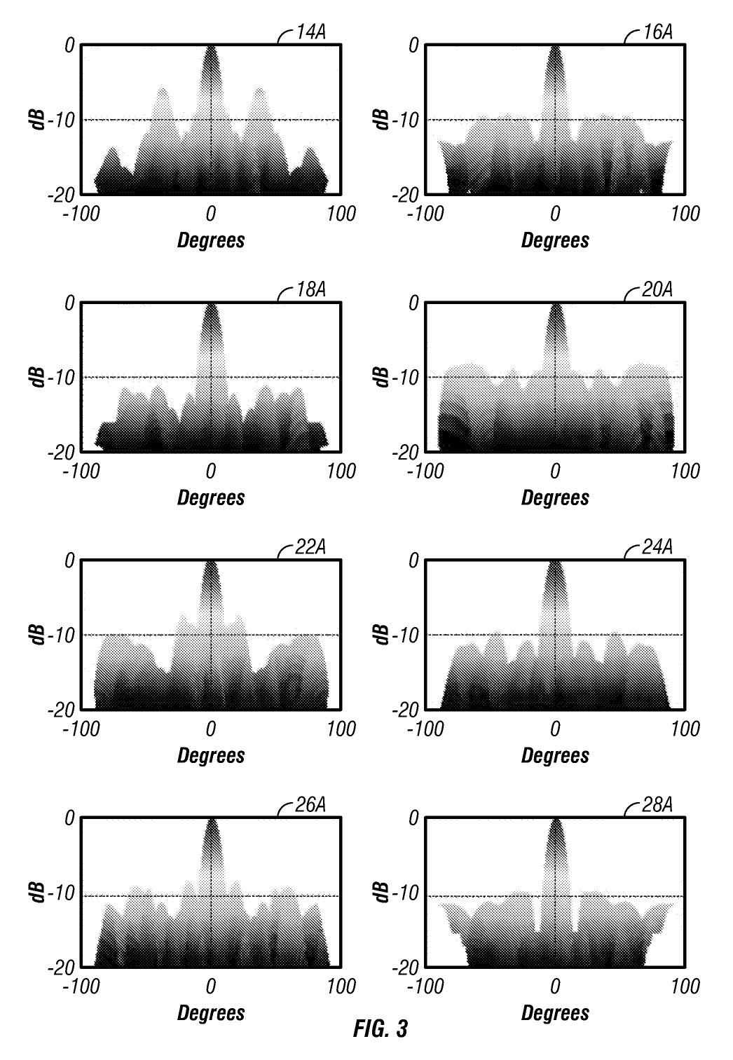

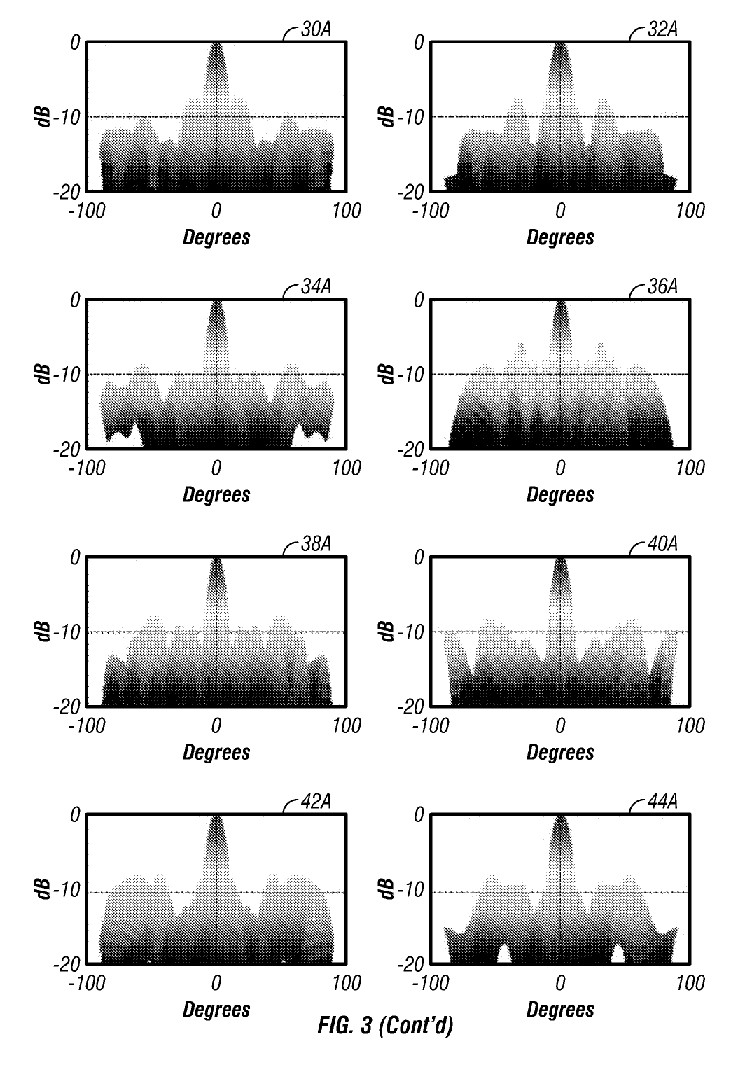

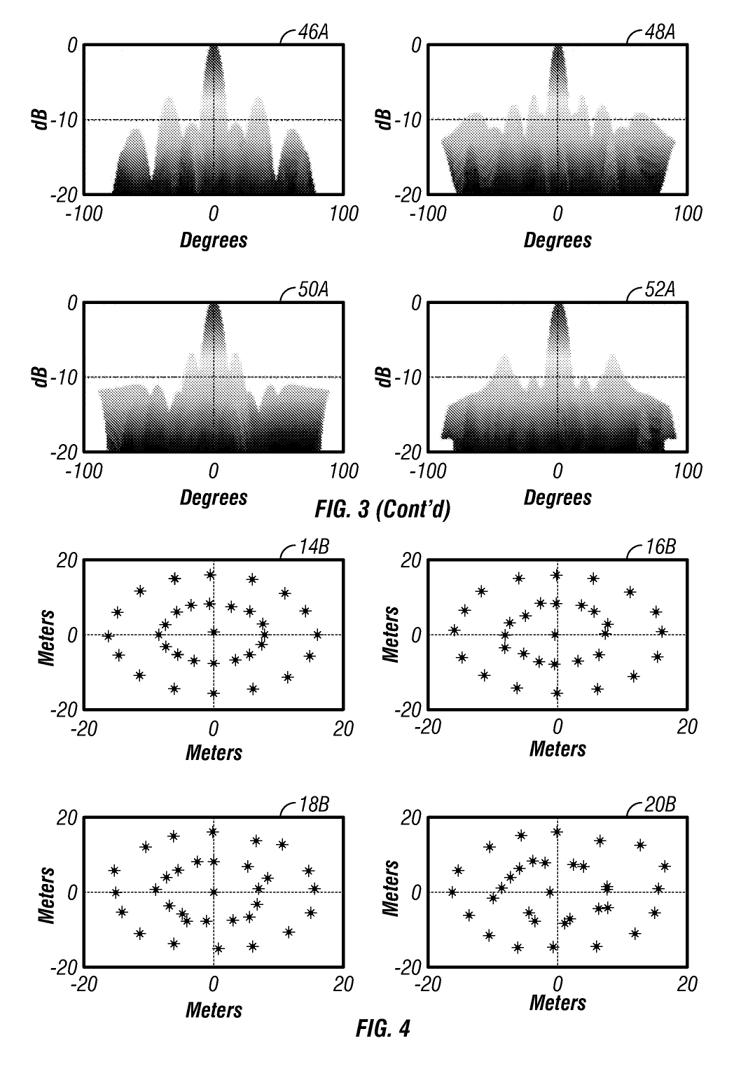

Simulated far field beam response of transmitters operated at each of the positions in each corresponding graph are shown in FIG. 3 at 14A through 52A. The simulated transmitters were operated as a steered beam array, wherein a single actuation of the array includes actuation of each transmitter in the array at a suitably delayed time based on the position of each transmitter in the array to cause the desired steered beam response. In the graphs of FIG. 3, the main beam of the steered response was straight down from the center of the array; that is, a steering angle of zero. A far field beam will be realized at about 100 meters range. The graphs in FIG. 3 demonstrate that randomly positionally distributed transmitters can be operated as a steered beam array. The coordinate (horizontal) axis in graphs 14A through 52A is scaled in degrees angle from the center of the array area, and the ordinate (vertical) axis is scaled in dB. Corresponding axis scaling applies to all the remaining graphs described below.

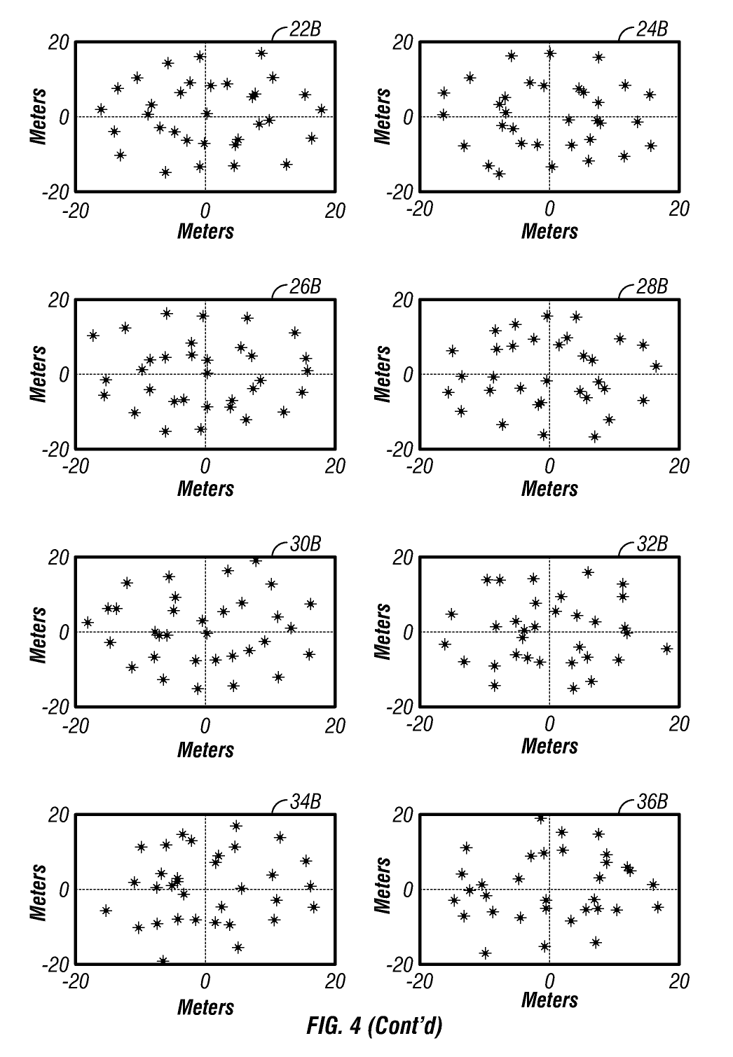

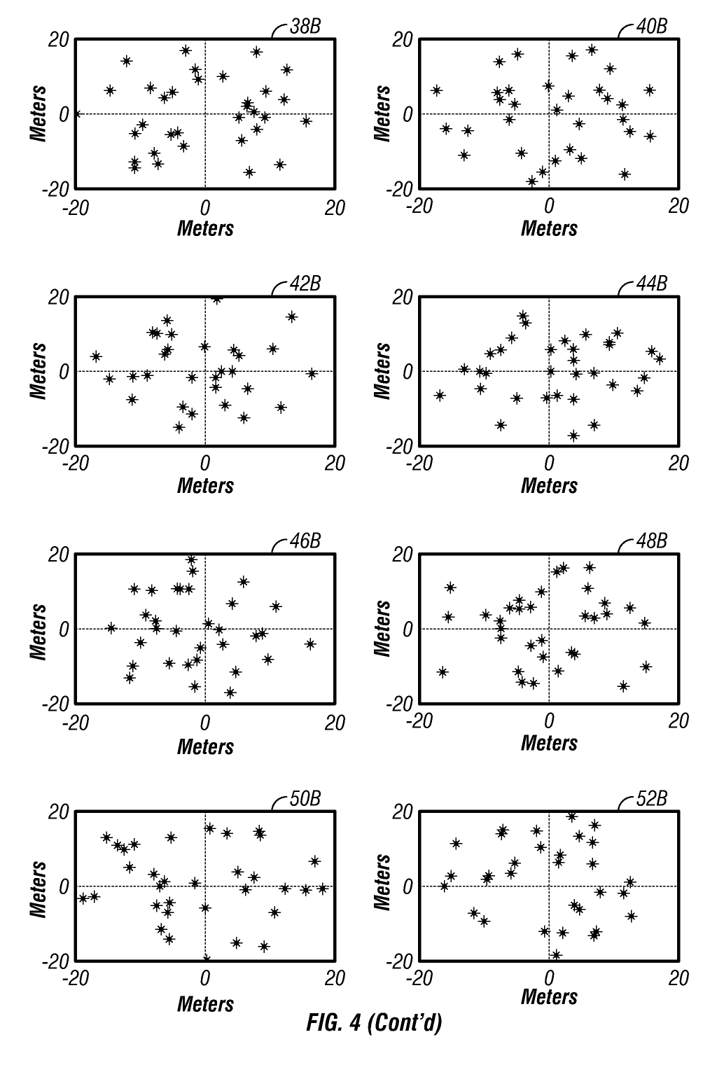

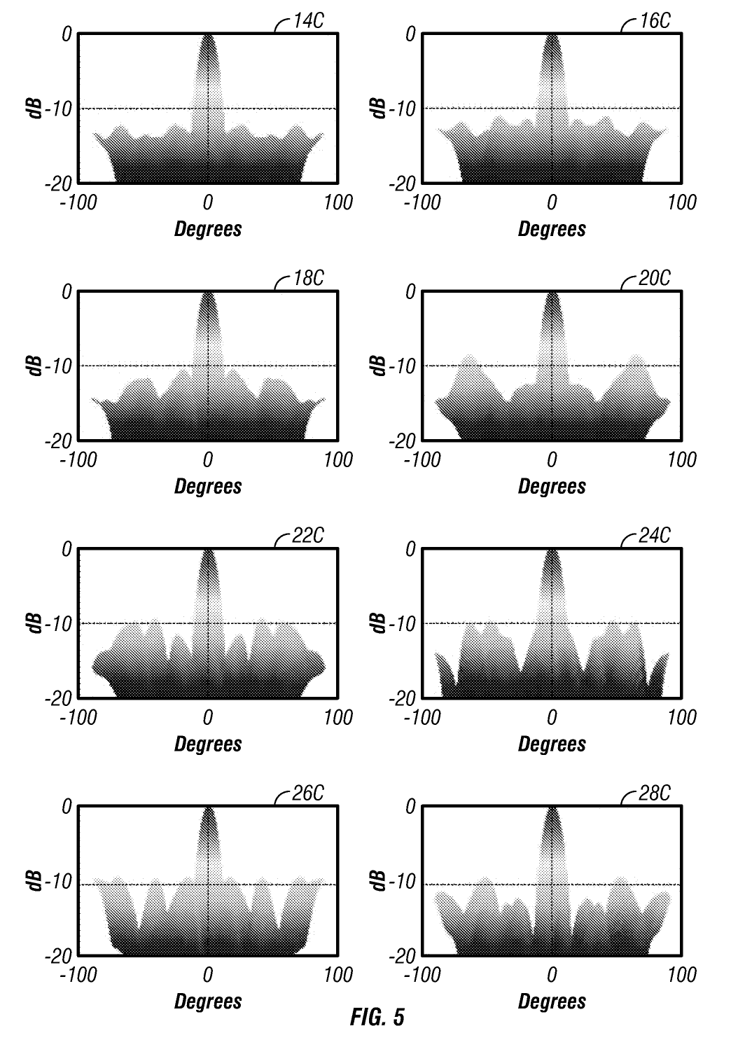

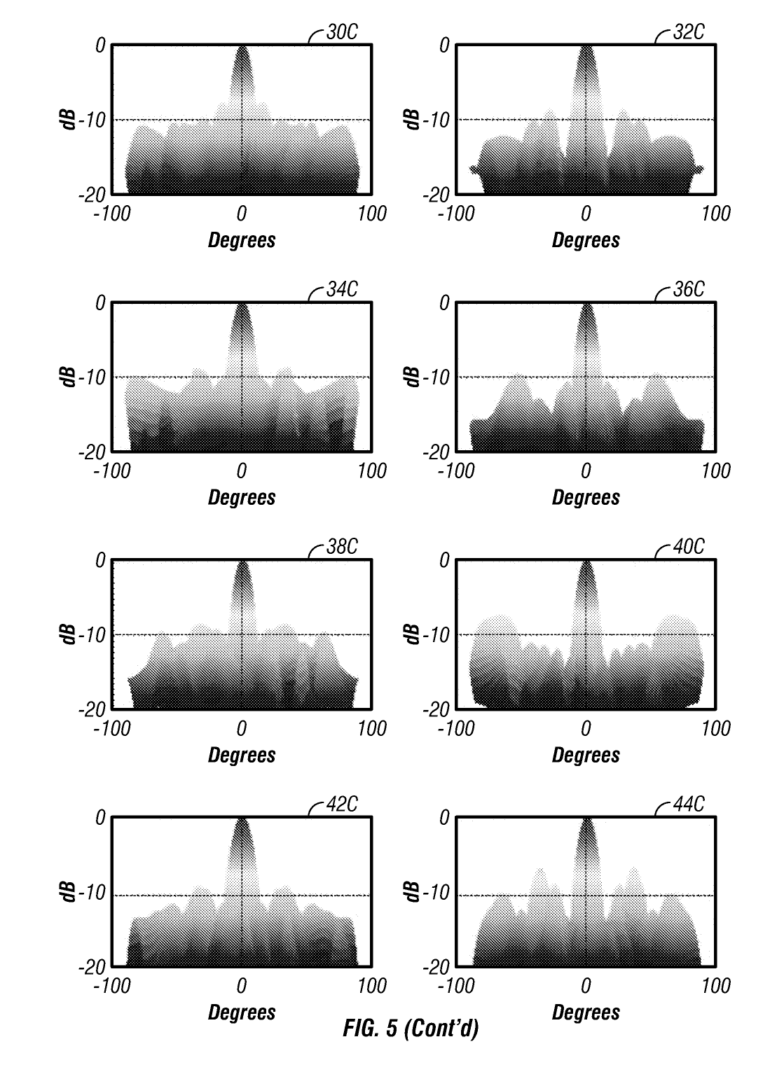

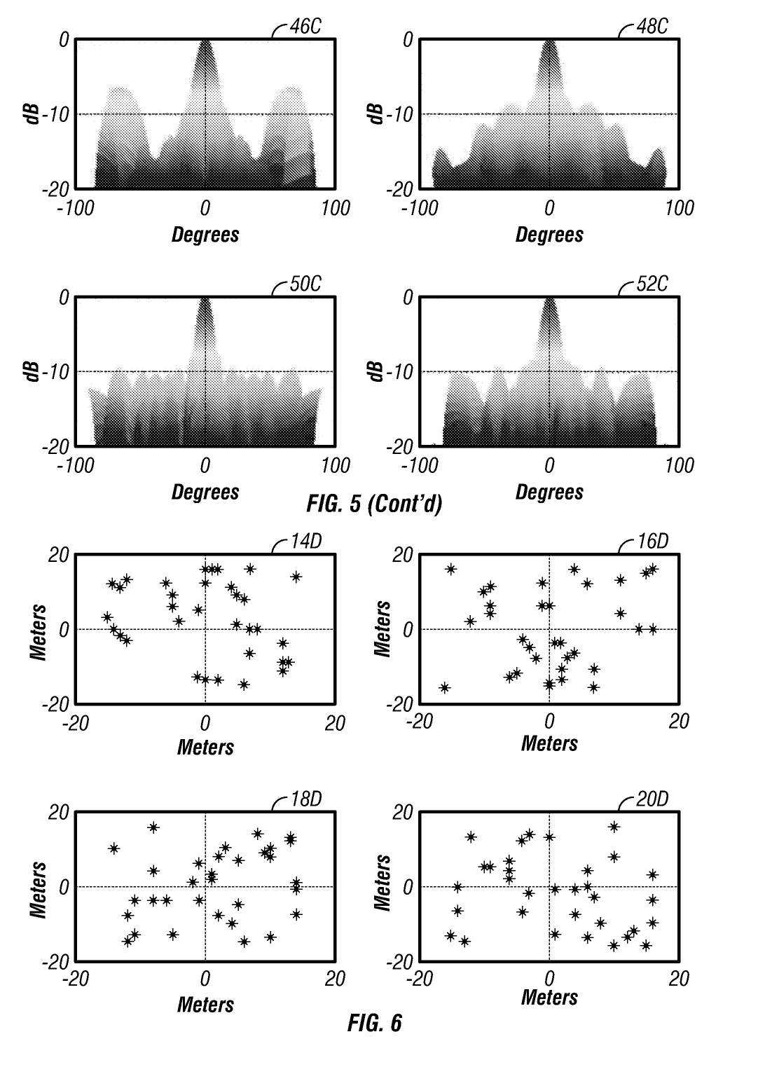

FIG. 4 shows, in graphs 14B through 52B, transmitter locations determined using the second transmitter position determination technique described above. What should be particularly noted in FIG. 4 is graph 14B, wherein the standard deviation index is zero. Graph 14B therefore represents the transmitter positions for the regular geometric array shown in FIG. 1, and its simulated beam response, explained below with reference to FIG. 5, indicates that randomly positionally distributed transmitters and regular geometric array placed transmitters have similar steered beam response.

The steered beam response for each set of transmitter positions shown in FIG. 4 is shown in corresponding graphs 14C through 52C in FIG. 5. The simulated array in each graph of FIG. 4 was operated with suitable time delay to beam steer straight down from the center of the array (beam steering angle of zero).

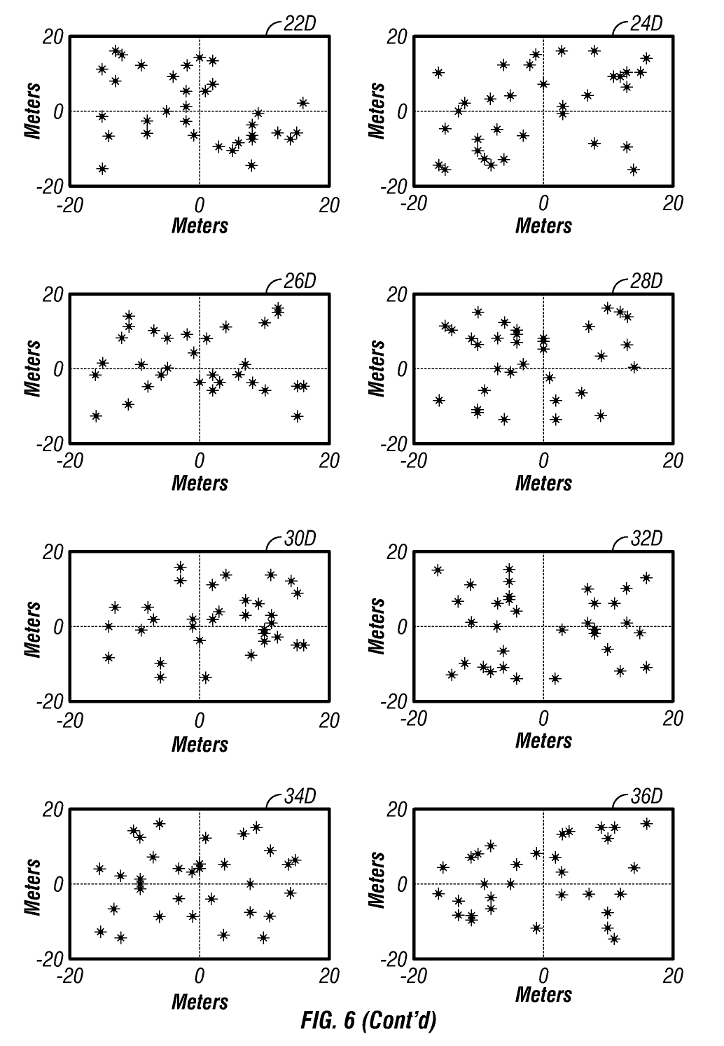

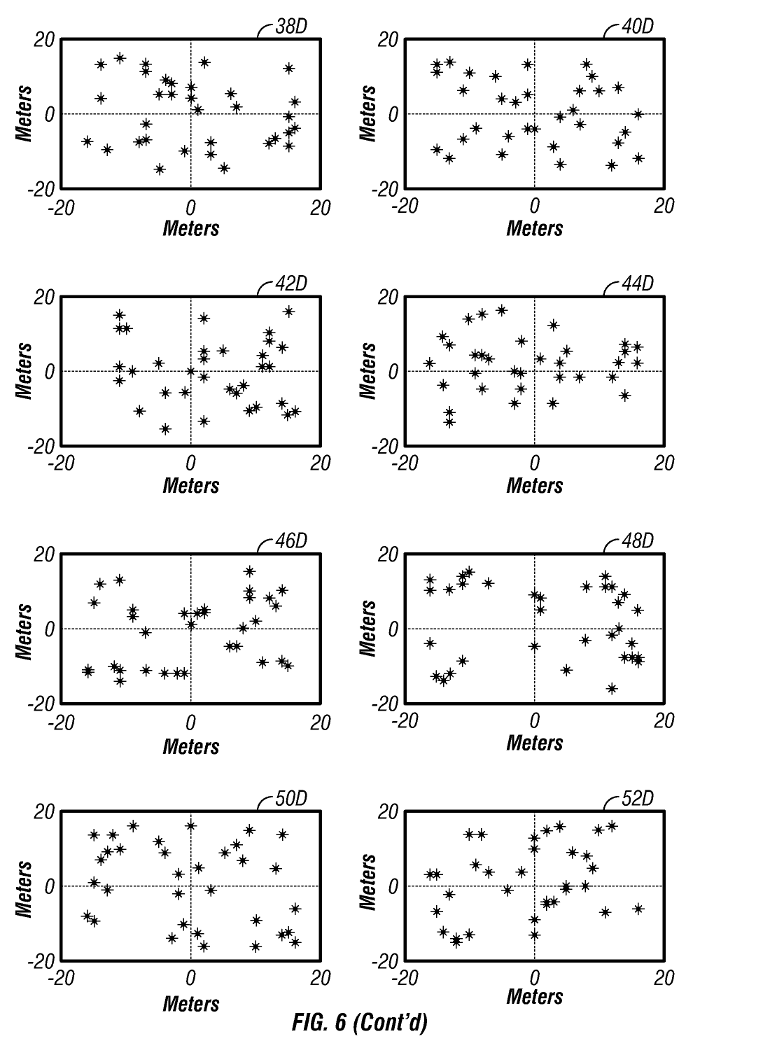

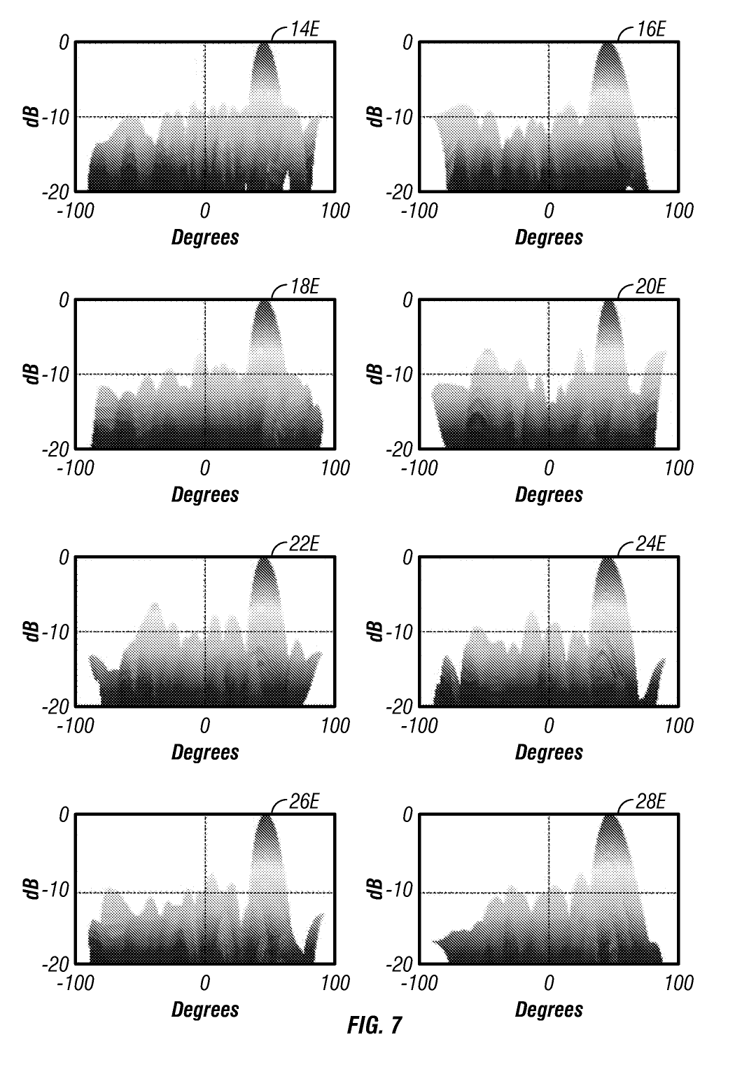

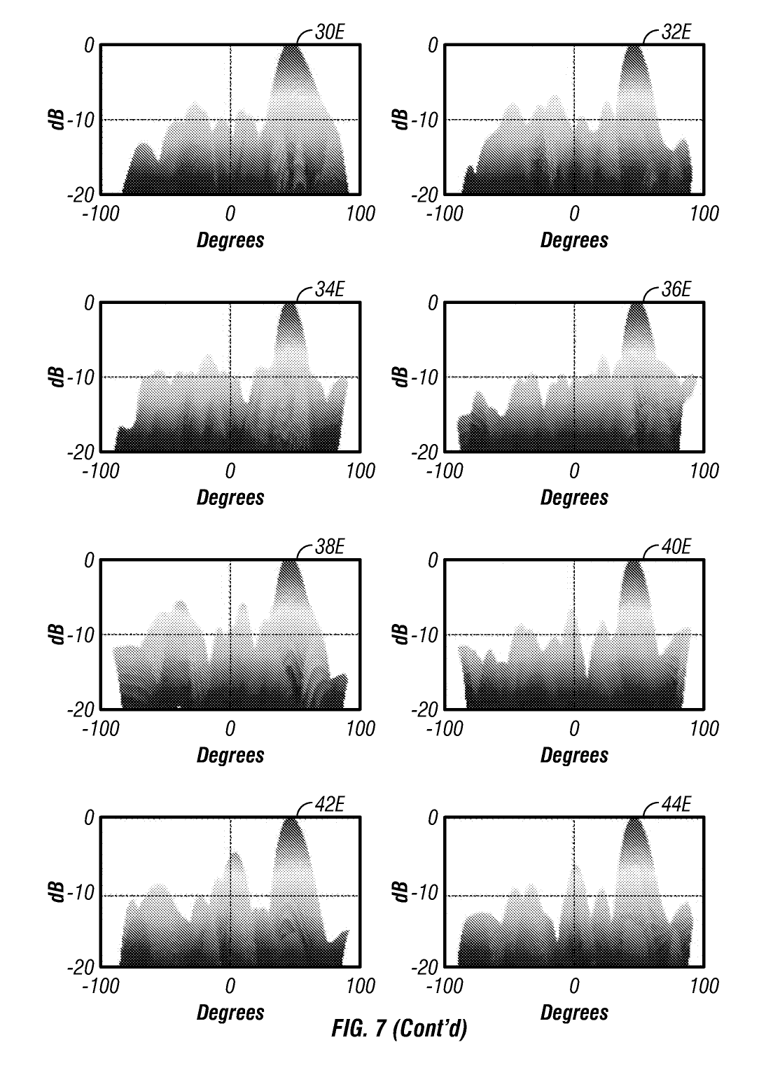

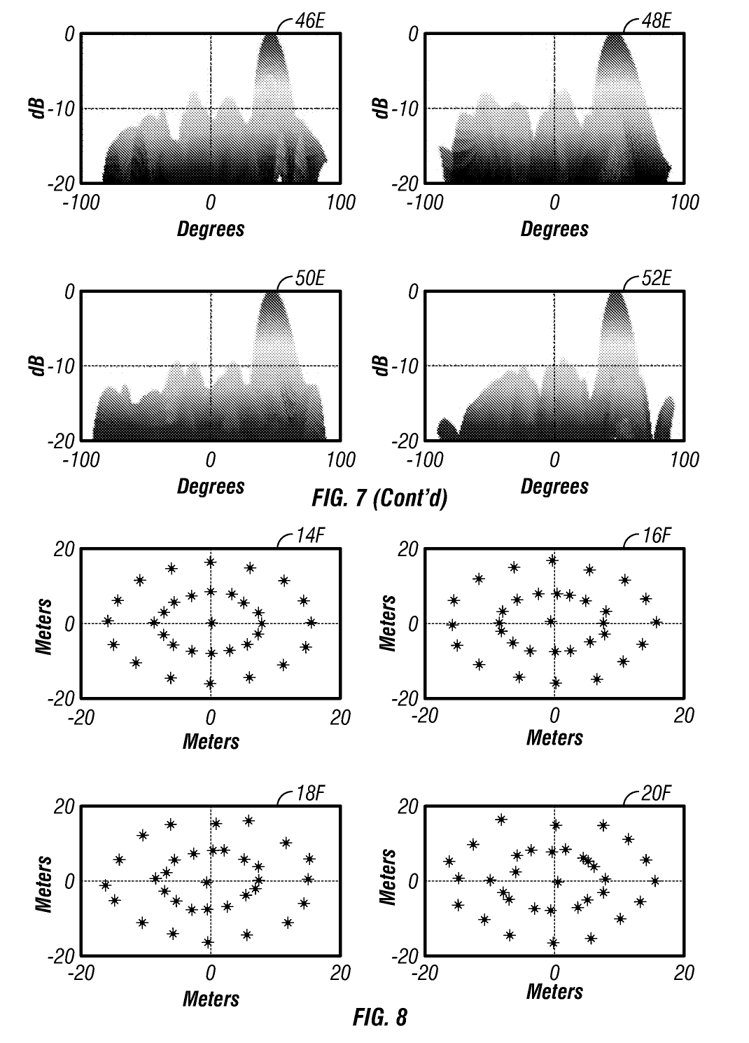

FIGS. 6 and 7 show, respectively, transmitter positions and corresponding steered beam response of each array in graphs 14D through 52D and 14E through 52E. The first transmitter position determination technique was performed an additional twenty times to produce the transmitter positions in each array in graphs 14D through 52D. In the example of FIGS. 6 and 7, the beam steering angle was 45 degrees.

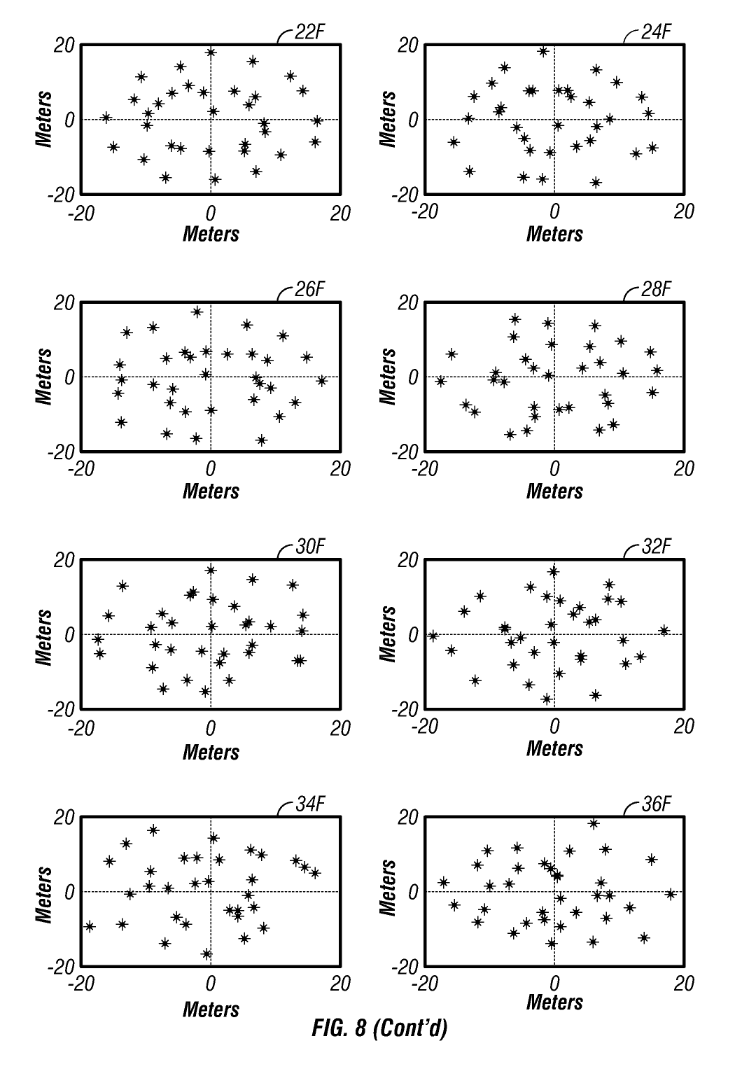

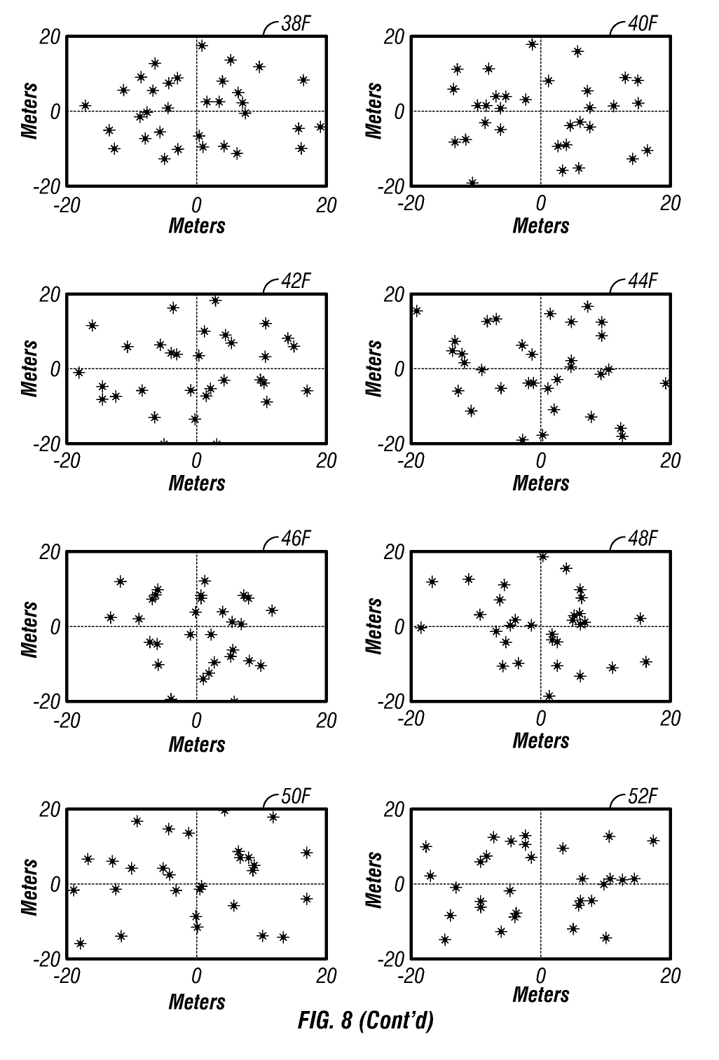

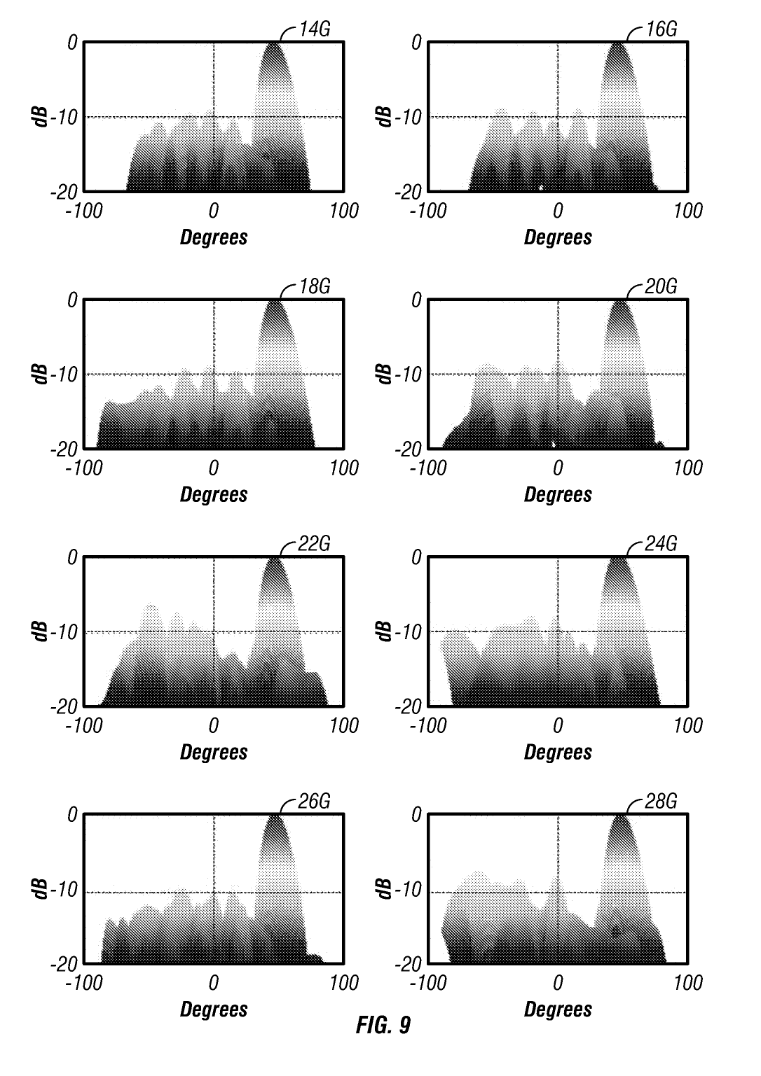

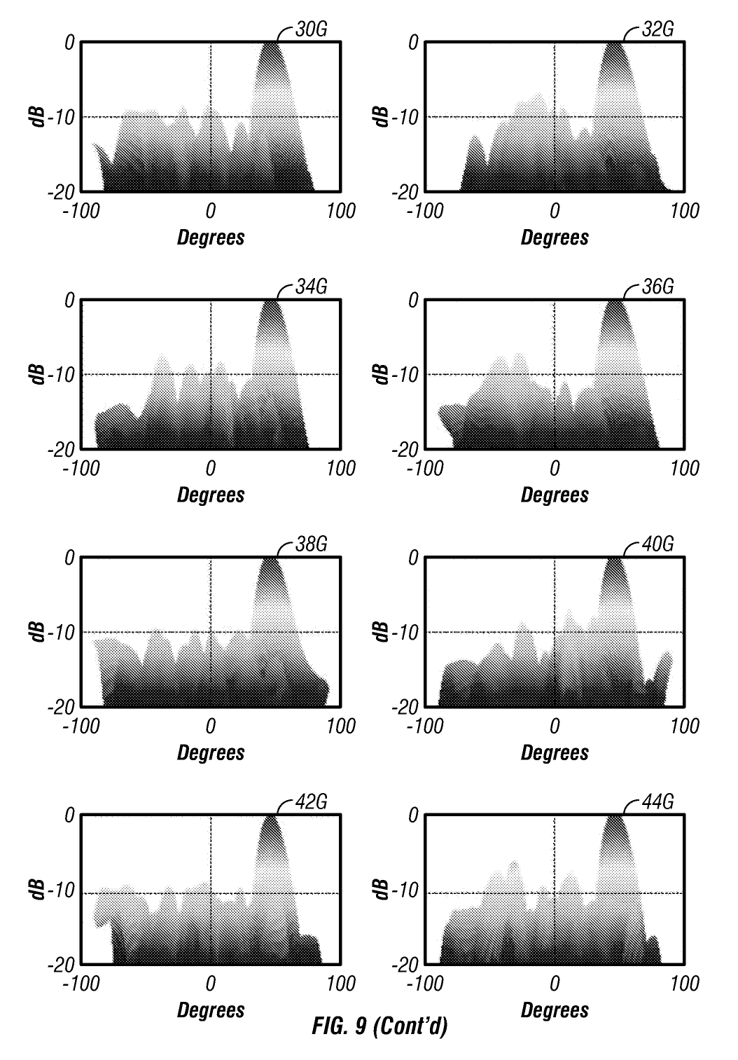

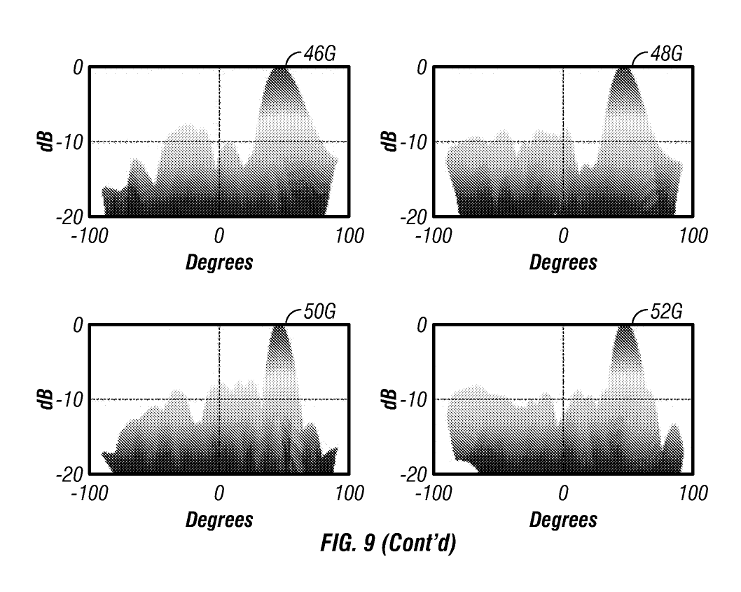

FIGS. 8 and 9 show transmitter position simulation using the second technique and the corresponding array response, respectively. In the graph 14F in FIG. 8, it should be particularly noted that the standard deviation index is zero, so the transmitter positions are the same as those in the regular geometric array shown in FIG. 1. In FIG. 9, the beam steered angle was 45 degrees.

The foregoing simulation results suggest that random distribution of transmitter positions within a selected area can provide a transmitter array with beam steering characteristics similar to a regular geometric array such as the concentric circular array shown in FIG. 1. The foregoing discovery has led to development of a deployment and operating technique for acoustic transmitters to be disposed on the bottom of a body of water.

An example transmitter that may be used in some implementations is shown schematically in FIG. 10. The transmitter 10 may include an acoustic driver 64, such as a piezoelectric transducer, disposed in a Helmholtz resonator tube 62. The tube 62 may be coupled to an electronic circuit housing 66. The housing 66 is preferably made from material that can resist hydrostatic pressure so as to exclude water from entering the interior thereof. The housing 66 is suspended in a substantially vertical orientation by a float 60 at the upper end thereof. An anchor 70 may be coupled to the upper end of the housing 66 by a controllable latch 68. The weight of the anchor 70 is selected such that when the entire transmitter as shown in FIG. 10 is released into a body of water, it rapidly sinks to the bottom. When the latch is released, however, the remainder of the transmitter 10 is buoyant.

In other examples, the acoustic driver 64 may be configured to detect seismic energy imparted into the subsurface and reflected from acoustic impedance boundaries in the subsurface. Other components of the device, explained below may be configured to record signals generated by the driver 64, typically indexed with respect to time. In beam steering response of the drivers is used as receivers, a time delay can be applied to the recording of each driver, in principle identically to that used to beam steer the response of the transmitters.

Referring to FIG. 10A, each acoustic transmitter 10 may contain a Global Positioning System (GPS) receiver 88. Knowledge of the geodetic position of each transmitter 10 at the time of deployment is obtained from a GPS geodetic position measurement at the point of release into the body of water. The accuracy of the position measurement will be affected by any drift that occurs during the transit from the surface to the water bottom. To augment the precision of the position determination, each transmitter 10 can include a high-frequency (e.g., in the 10-40 KHz range) acoustic transducer 84 that can be operated as both an Ultra-Short Baseline (USBL) beacon and an acoustic modem transducer. USBL positioning methods known in the art can be used to refine the geodetic position of each transmitter 10. While precise geodetic position of each transmitter 10 on the water bottom is desirable to obtain, the USBL technique used should enable highly precise relative positions of each transmitter within the array relative to the acoustic wavelength of interest. As will be appreciated by those skilled in the art, precise relative position information is required in order to select appropriate time delay for operating each transmitter 10 for correct beam steering.

An appropriately programmed microprocessor unit (MPU) 80 in the housing 66 contains the operating instructions for the transmitter 10. A time reference for this MPU in the present example is a commercially available chip-scale atomic clock 82 of typical accuracy better than 3 mS/year. The deployment vessel (FIG. 11), fitted with a USBL system and acoustic modem, transmits the precise coded location of each transmitter 10 to all the other transmitters in the array. Each transmitter 10 receives this data (using transducer 84) and identifies its location by recognizing its code. The MPU 80 then calculates the timing necessary for the output of the respective transmitter 10 to add in a phase-coherent manner to the other transmitters in the array for a variety of pre-programmed, steered-beam transmissions.

Transmissions are initiated either at pre-set times or by data message from the deployment vessel (FIG. 11) received over the acoustic modem link. When a transmission of an acoustic signal into the subsurface is to take place, the MPU 80 generates a suitable driver signal, which may be amplified in a power amplifier 90, such amplified signal being conducted to the transducer (64 in FIG. 10) in the resonator (62 in FIG. 10). The transmission timing for phase addition schemes corresponding to the desired near-field acoustic beam patterns can be pre-programmed in the MPU 80 operating instructions, or can be communicated to each of the transmitters from the vessel (11 in FIG. 1) using the acoustic modem link.

Each transmitter 10, as explained above includes a latch 68, which may be acoustically operated by modem command from the deployment vessel (FIG. 11), making it possible for an individual transmitter 10 or the entire array to be retrieved from the water bottom by sending the appropriate commands from the deployment vessel. A transmitter 10 that reaches the water surface will re-establish its GPS location coordinates and periodically transmit this information, for example, on a commercial marine satellite service, to the deployment vessel using a radio frequency transmitter 86. Thus, each transmitter 10 can be located by the deployment vessel and readily retrieved.

The foregoing example described with reference to FIG. 10A is only one example of the types of acoustic transmitters that may be used in accordance with the invention. Other examples include, without limitation, air guns, water guns and marine vibrators. The type of transmitter is not a limit on the scope of the present invention.

Referring to FIG. 11, the deployment vessel 100 moves along the surface of a body of water 106. The vessel 100 may include equipment, shown generally at 102, which may include devices (not shown separately) for determining geodetic position of the vessel 100, for receiving geodetic positing information from transmitters as explained above, for communicating commands to the transmitters 10 on the water bottom 108 and for preprogramming transmitters 10. At selected locations within an area for deployment of a transmitter array, transmitters 10, for example as explained with reference to FIGS. 10 and 10A may be released into the water 106 from the vessel 100. The released transmitters 10 eventually sink to the water bottom 108. The sinking may be substantially unguided, that is, none of the elements of the transmitters 10 functions to control the direction of descent through the water other than by gravity. The transmitters 10 may then have their relative positions determined as explained above using the acoustic modem 104 on the vessel 100, and seismic surveys may be conducted by operating the transmitters 10 as a steered beam array. Upon completion of the surveys, one or more of the transmitters 10 may be retrieved by releasing the latch (68 in FIG. 10A) thus allowing the transmitter less the anchor (70 in FIG. 10) to float to the surface, one example of which is shown in FIG. 11. The floating transmitters 10 may be recovered by receiving a GPS signal, and transmitting the geodetic position determined therefrom to the vessel 100.

A plan view in FIG. 11A shows the transmitters 10 randomly spatially distributed on the water bottom as a result of deployment from the vessel 100.

A method of deploying an acoustic transmitter array in a body of water for seismic surveying enables efficient deployment from a vessel by simple release of the transmitters into the water. The method does not require precise control of the direction of motion of individual transmitters on their way to the water bottom for placement in a defined geometric pattern. Even with essentially random positional distribution of the transmitters on the water bottom, the transmitters may be operated as a beam steered array.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for at least one of imparting seismic energy into formations below the bottom of a body of water and detecting seismic energy therefrom, comprising:
releasing into the water from proximate the water surface a plurality of acoustic transducers, the transducers moving to the bottom by gravity;
determining a geodetic position of each of the transducers on the water bottom; and
at least one of actuating each of the transducers as a transmitter at least once, the actuating of each transducer occurring at a time selected to cause seismic energy to be imparted into the formations in a beam along a selected direction, the selected time related to relative positions of the transducers, and recording signals detected by each of the transducers, the recording including adding a selected time delay to cause response of the transducers to be amplified along a selected direction.

2. The method of claim 1 wherein the determining geodetic position comprises measuring a global positioning system position of each transducer at a time of release thereof, and determining the relative positions using an range locating acoustic transducer associated with each transducer when the transmitters are on the water bottom.

3. The method of claim 1 further comprising releasing at least one of the transducers from an anchor associated therewith so that the at least one transmitter floats to the water surface, determining a geodetic position of the at least one transmitter on the water surface and communicating the water surface geodetic position to a recovery vessel.

4. The method of claim 1 wherein the moving to the water bottom is substantially unguided.

5. The method of claim 1 wherein each transducer comprises an acoustic driver disposed in a Helmholtz resonator.
